(19) United States
(12) Patent Application Publication
(10) Pub. No.: US 2010/0260880 A1
(43) Pub. Date: Oct. 14, 2010

(54) Mold for Manufacturing an Outsole with Fabric Bottom

(76) Inventor: Kun-Chu Lin, Fengyuan City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/422,328

(22) Filed: Apr. 13, 2009

(51) Int. Cl. B29C 33/40

(52) U.S. Cl. 425/117

(57) ABSTRACT

An outsole mold includes a cover comprising a plurality of sprues; and a body having one end hingedly connected to the cover and comprising a cavity to be filled with a molten plastic via the sprues, and a raised peripheral wall around a predetermined portion of the cavity. The raised peripheral wall has a predetermined height. The raised peripheral wall is adapted to position a fabric member therein prior to pouring the molten plastic into the cavity. The produced outsole has the fabric member on its bottom.

### BACKGROUND OF THE INVENTION

1. Field of Invention

The invention relates to outsole molds and more particularly to an outsole mold having a raised peripheral wall in the mold cavity for positioning a fabric member therein such that a portion of the bottom of the outsole can be formed with the fabric member.

2. Description of Related Art

A conventional process of manufacturing outsoles involves the steps of pouring plastic powder or pellets into a barrel, heating the barrel to melt the plastic powder or pellets, injecting the molten plastic into a cavity of a mold, cooling the mold, and removing the finished outsole by opening the mold.

However, the well known outsole manufacturing process suffers from a couple of disadvantages. In detail, excessive plastic is formed on the outsole. It is known that the heavier of outsole (i.e., the more plastic being consumed) the more of customs tax will be. This can increase the unit cost of outsole and thus the total manufacturing cost. Also, an outsole produced by the conventional mold is monotonous in terms of appearance. Thus, the need for improvement still exists.

### SUMMARY OF THE INVENTION

It is therefore one object of the invention to provide an outsole mold having a raised peripheral wall in the mold cavity for positioning a fabric member therein such that a portion of the bottom of the outsole can be formed with the fabric member.

To achieve the above and other objects, the invention provides a mold for manufacturing an outsole comprising a cover comprising a plurality of sprues; and a body having one end hingedly connected to the cover and comprising a cavity to be filled with a molten plastic via the sprues, and a raised peripheral wall around a predetermined portion of the cavity, wherein the raised peripheral wall has a predetermined height; and wherein the raised peripheral wall is adapted to position a fabric member therein prior to pouring the molten plastic into the cavity.

In one aspect of the invention the raised peripheral wall is closed and flanged.

In another aspect of the invention the raised peripheral wall comprises a plurality of curved sections.

In a further aspect of the invention the predetermined height of the raised peripheral wall is of more than 0.8 mm.

By utilizing the invention, the following advantages are obtained.

The provision of a raised peripheral wall can position a fabric member in a mold cavity during a manufacturing process of an outsole.

The raised peripheral wall can be configured in one of a wide variety of shapes in order to correspond to a fabric member of special shape. Hence, a wide variety of outsoles with different bottoms can be produced.

The fabric member as a portion of the bottom of outsole can decrease the consumption of plastic material in the manufacturing of outsole. As a result, both customs tax and the manufacturing cost are reduced. Further, the bottom of the outsole can be made more aesthetic, colorful, and as one of a wide variety of patterns.

The plastic material of the outsole is TPE, TPU, or TPR and has the features of being good in ventilation, lightweight, and no stitches.

The above and other objects, features and advantages of the invention will become apparent from the following detailed description taken with the accompanying drawings.

### BRIEF DESCRIPTION OF THE DRAWINGS

FIG. 1 is a perspective view of a preferred embodiment of outsole mold according to the invention where the outsole is open with a fabric member to be positioned in a cavity of the mold;

FIG. 2 is a sectional view of the outsole mold; and

FIG. 3 is a perspective view of the finished outsole.

### DETAILED DESCRIPTION OF THE INVENTION

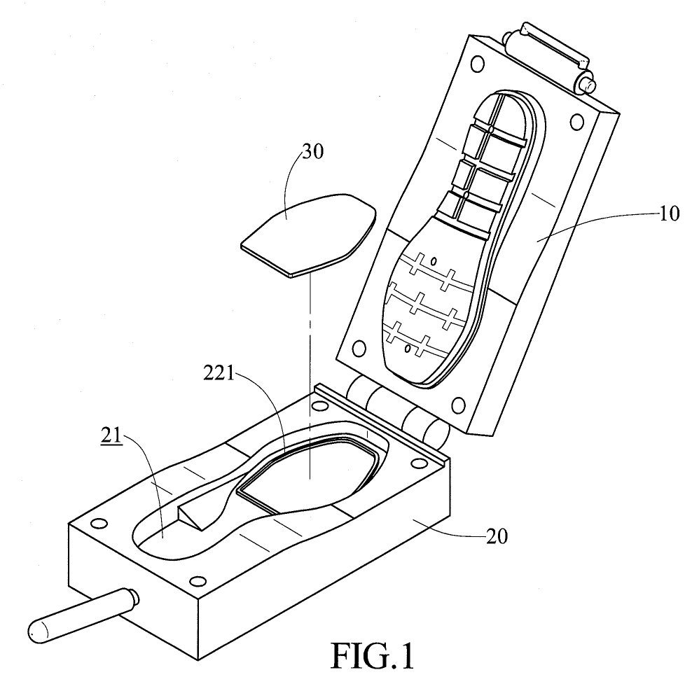

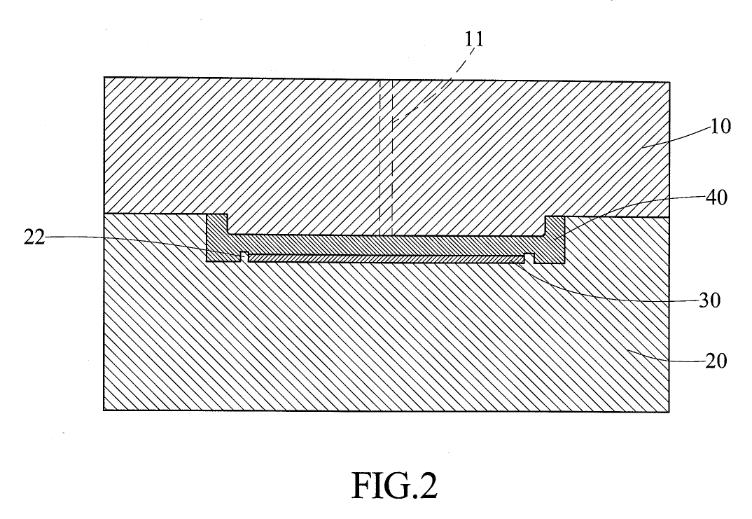

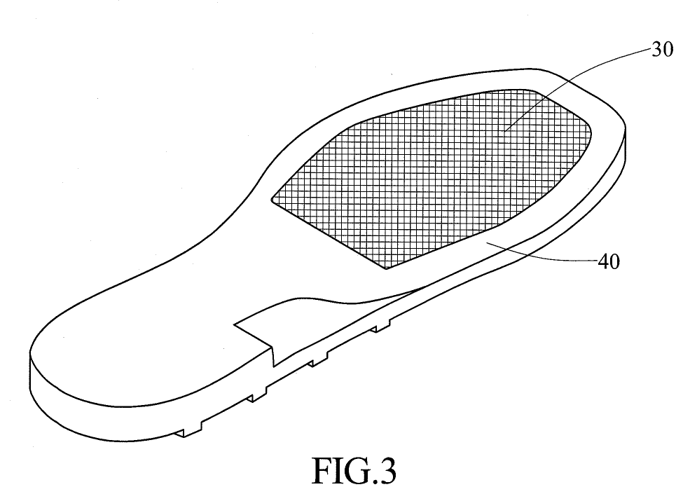

Referring to FIGS. 1 to 3, an outsole mold in accordance with a preferred embodiment of the invention is shown. The outsole mold is a parallelepiped and comprises a body 20 and a cover 10 hingedly connected thereto. The cover 10 comprises a plurality of sprues 11 having one ends open to the top surface and the other ends open to the body 20. Plastic powder or pellets to be melted in this outsole manufacturing process can be thermoplastic elastomer (TPE), thermoplastic rubber (TPR), or thermoplastic polyurethane (TPU).

The body 20 comprises a cavity 21 shaped as an outsole and a raised peripheral wall 22 around a front portion of the cavity 21 (i.e., surrounding a portion from the shoe toe to the shoe arch of the cavity 21). A fabric member 30 is adapted to position in a recessed area defined by the raised peripheral wall 22. Preferably, the fabric member 30 is made of non-woven fabric.

The outsole manufacturing process of the invention involves the steps of placing the fabric member 30 in a portion of the cavity 21 surrounded by the raised peripheral wall 22, pouring plastic powder or pellets into a barrel, heating the barrel to melt the plastic powder or pellets, injecting the molten plastic into the cavity 21 of the mold 20 through the sprues 11, cooling the mold 20, and opening the mold 20 to remove a finished outsole 40 with the fabric member 30 formed on the bottom thereof.

Advantageously, the provision of the raised peripheral wall 22 can position the fabric member 30 during the manufacturing process of the outsole 40.

Preferably, the raised peripheral wall 22 is closed and flanged.

Preferably, the raised peripheral wall 22 comprises a plurality of curved sections 221.

Preferably, the raised peripheral wall 22 has a height of more than 0.8 mm.

The invention has the following advantages.

The provision of a raised peripheral wall can position a fabric member in a mold cavity during the manufacturing process of an outsole.

The raised peripheral wall can be configured in a shape other than the shown one in order to correspond to a fabric member of special shape. As a result, a wide variety of outsole s with different bottoms can be produced.

The fabric member as a portion of the bottom of outsole can decrease the consumption of plastic material in the manufacturing of outsole. As a result, both customs tax and the manufacturing cost are reduced. Further, the bottom of the outsole can be made more aesthetic, colorful, and as one of a wide variety of patterns.

The plastic material of the outsole is TPE, TPU, or TPR and has the features of being good in ventilation, lightweight, and no stitches.

While the invention herein disclosed has been described by means of specific embodiments, numerous modifications and variations could be made thereto by those skilled in the art without departing from the scope and spirit of the invention set forth in the claims.

What is claimed is:

1. A mold for manufacturing an outsole comprising:
a cover comprising a plurality of sprues; and
a body having one end hingedly connected to the cover and comprising a cavity to be filled with a molten plastic via the sprues, and a raised peripheral wall around a predetermined portion of the cavity,
wherein the raised peripheral wall has a predetermined height; and
wherein the raised peripheral wall is adapted to position a fabric member therein prior to pouring the molten plastic into the cavity.

2. The mold of claim 1, wherein the raised peripheral wall is closed and flanged.

3. The mold of claim 2, wherein the raised peripheral wall comprises a plurality of curved sections.

4. The mold of claim 1, wherein the predetermined height of the raised peripheral wall is of more than 0.8 mm.
